(19) United States
(12) Patent Application Publication
(10) Pub. No.: US 2011/0185541 A1
(43) Pub. Date: Aug. 4, 2011

(54) STRAP ADJUSTMENT DEVICE

(76) Inventor: ROBERT HENRY GUPTILL, Lampasas, TX (US)

(21) Appl. No.: 13/015,383

(22) Filed: Jan. 27, 2011

Related U.S. Application Data
(60) Provisional application No. 61/300,105, filed on Feb. 1, 2010.

(51) Int. Cl. F16G 11/04; F16G 11/00

(52) U.S. Cl. 24/134 R; 24/115 R

(57) ABSTRACT

A strap adjustment device may be slid onto a cord or strap to adjust its useful length and the tension provided by the cord or strap. The strap adjustment device may include a housing, a first opening on a first end the housing for accepting a length of material through the housing, the first opening having a first portion and a second portion, the first portion having an arc shape, the second portion having a rectangular shape, and the first portion contiguously adjoining the second portion to form the first opening, and a locking mechanism for securing a portion of the length of material within the housing.

### CROSS-REFERENCE TO RELATED APPLICATIONS

This application claims the benefit of priority to U.S. provisional patent application No. 61/300,105 filed Feb. 1, 2010, and incorporated herein by reference.

### BACKGROUND OF THE INVENTION

The present invention generally relates to a strap adjustment device, and more particularly relates to a device that may be used in conjunction with a variety of differently shaped and sized straps to adjust the useful length of a strap as well as the tension provided by the strap.

Currently, bungee straps are often used, for example, to secure items such as pieces of luggage to luggage racks on vehicles. However, bungee straps of different lengths are often needed to secure pieces of luggage of different sizes and shapes, thus forcing a user to purchase many different bungee straps of different lengths.

As can be seen, there is a need for a strap adjustment device which can be used with a variety of differently shaped and sized straps, ropes, cords, belts, and/or other lengths of material, such as rubber ropes and rubber cords, for adjusting the useful length and tension of a strap used in conjunction with the device.

### SUMMARY OF THE INVENTION

In one aspect of the present invention, a device comprises a housing; a first opening on a first end the housing for accepting a length of material through the housing, the first opening having a first portion and a second portion, the first portion having an arc shape, the second portion having a rectangular shape, and the first portion contiguously adjoining the second portion to form the first opening; and a locking mechanism for securing a portion of the length of material within the housing.

These and other features, aspects and advantages of the present invention will become better understood with reference to the following drawings, description and claims.

### BRIEF DESCRIPTION OF THE DRAWINGS

FIG. 1 shows a perspective view of a strap adjustment device in accordance with an embodiment of the present invention illustrating a locked position;

FIG. 2 shows a perspective view of the strap adjustment device of FIG. 1 illustrating an unlocked position;

FIG. 3 shows an exploded perspective view of the strap adjustment device of FIG. 1;

FIG. 4 shows a section view of the strap adjustment device of FIG. 1 taken along line 4-4 in FIG. 2;

FIG. 5 shows a detail section view of the strap adjustment device of FIG. 1 illustrating the locked position; and

FIG. 6 shows a top view of the strap adjustment device of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a device that may be used in conjunction with a variety of differently shaped and sized straps to adjust the useful length of a strap as well as the tension provided by the strap.

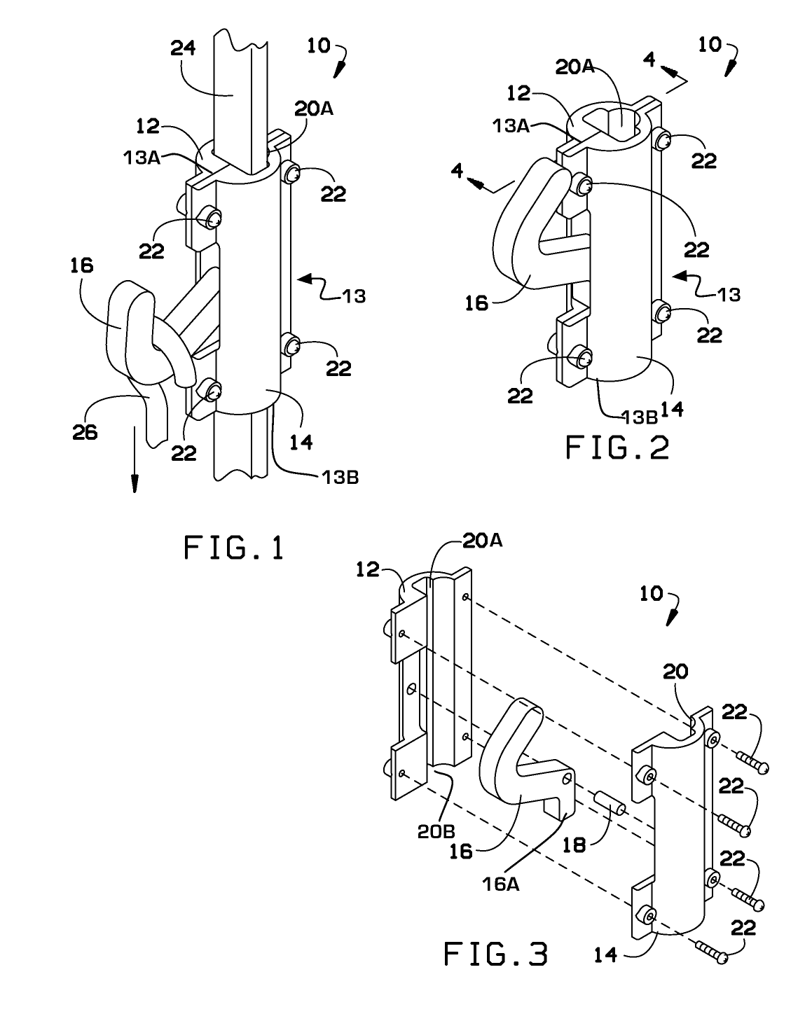

With reference to FIGS. 1, 2, and 3, a strap adjustment device 10 may include a housing 13 which may be slid onto a length of material such as a bungee strap 24 in order to adjust the useful length and the tension provided by the strap 24. The housing 13 may be hollow and tubular-shaped and may have a first opening 20A at a first housing end 13A, a second opening 20B at a second housing end 13B having the same shape as the first opening 20A, and a hollow tunnel running from the first opening 20A to the second opening 20B.

The housing 13 may receive the strap 24 through the first opening 20A, and the strap 24 may leave the housing 13 through the second opening 20B. The housing 13 may be slid up and down the strap 24 and the housing 13 may be secured to the strap 24 via a locking mechanism, such as a cam lever 16, when it is at a desired location on the strap 24.

The housing 13 may be constructed from a left housing 12 and a right housing 14, which may be connected via fasteners 22, such as screws, to complete the housing 13.

With reference to FIG. 6, the first opening 20A and second opening 20B on the housing 13 may be shaped so that the housing 13 may be slid onto straps 24 having a variety of sizes and shapes. To that end, the first opening 20A may be made up of a first portion 20C having an arc shape, such as a semi-circular shape, and a second portion 20D having a rectangular shape that contiguously adjoins the first portion 20C to make up a single first opening 20A.

The first portion 20C and the second portion 20D of the first opening 20A may be disposed so that the second portion 20D of the opening may be situated to abut the length of the diameter side of the semi-circular shaped first portion 20C. Further, the width of the rectangular shaped second portion 20D may be wider than the diameter of the semi-circular shaped first portion 20C (and thus may extend past the edges of the semi-circular shaped first portion 20C on both sides).

In addition, the first portion 20C and the second portion 20D of the first opening 20A may be of sufficient size to receive the strap 24 having a circular cross-section with a diameter equal to the diameter of the semi-circular shape of the first portion 20C of the first opening 20A, so that the first portion 20C is able to receive a first semi-circular portion of the circular cross-section of the strap 24, and the second portion 20D is able to receive a second semi-circular portion of the circular cross-section of the strap 24.

The rectangular shaped second portion 20D of the first opening 20A may also be able to receive the strap 24 having a rectangular cross-section with the same dimensions as the rectangular shaped second portion 20D. Thus, the strap adjustment device 10 may be versatile in that it may be able to receive and secure many different straps 24 having different shapes, such as straps 24 having a circular or rectangular cross-section.

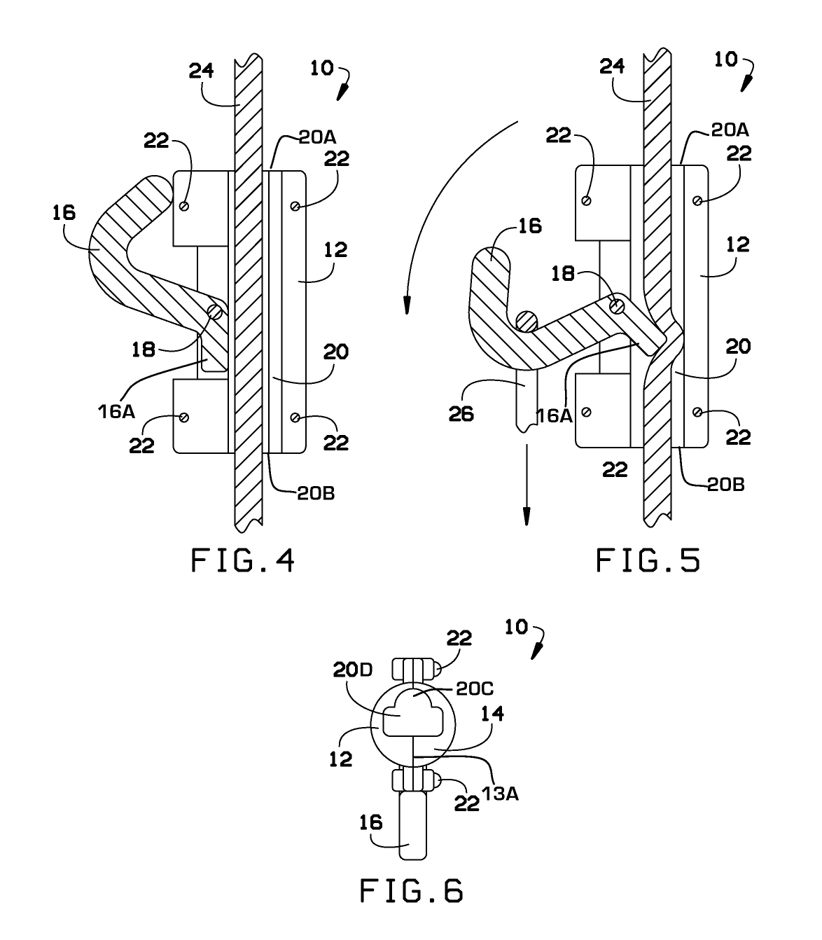

Referring now to FIGS. 4 and 5, the cam lever 16, may be used to lock and secure the strap 24 to the housing 13. The cam lever 16 may be pivoted at a pivot pin 18 so that the cam lever 16 may be moved to a locked position and an unlocked position.

When the cam lever 16 is moved to the locked position, a leg 16A of the cam lever 16 may be positioned so that it may push a portion of the strap 24 within the housing 13 against an interior wall of the housing 13, thereby securing the strap 24 with the housing.

Alternatively, when the cam lever 16 is moved to the unlocked position, the cam lever 16 may be positioned so that the leg 16A no longer pushes the portion of the strap 24 within the housing against the interior wall of the housing 13. The cam lever 16 may also be connected to a hook 26 which may apply additional tension to the cam lever 16 when the cam lever is in the locked position.

It should be understood, of course, that the foregoing relates to exemplary embodiments of the invention and that modifications may be made without departing from the spirit and scope of the invention as set forth in the following claims.

What is claimed is:

1. A device comprising:
a housing;
a first opening on a first end the housing for accepting a length of material through the housing, the first opening having a first portion and a second portion, the first portion having an arc shape, the second portion having a rectangular shape, and the first portion contiguously adjoining the second portion to form the first opening; and
a locking mechanism for securing a portion of the length of material within the housing.

2. The device of claim 1, wherein the first portion of the first opening on the housing has a semi-circular shape.

3. The device of claim 2, wherein the rectangular shape of the second portion is wider than a diameter of the semi-circular shape of the first portion.

4. The device of claim 3, wherein:
the first portion of the first opening and the second portion of the first opening are able to receive the length of material having a circular cross-section and a diameter equal to the diameter of the semi-circular shape of the first portion;
the first portion of the first opening is able to receive a first semi-circular portion of the circular cross-section of the length of material; and
the second portion of the first opening is able to receive a second semi-circular portion of the circular cross-section of the length of material.

5. The device of claim 1, wherein the locking mechanism is movable to a locked position and an unlocked position.

6. The device of claim 5, wherein the locking mechanism comprises a cam lever.

7. The device of claim 6, wherein the cam lever includes a leg for pushing a portion of the length of material within the housing against an interior wall of the housing when the locking mechanism is in the locked position.

8. The device of claim 4, further comprising a second opening on a second end of the housing opposite the first end of the housing.

9. The device of claim 8, wherein the second opening has a same shape as the first opening.

10. The device of claim 9, further comprising a tunnel having a same shape as the first opening and that runs from the first opening to the second opening.
